(19) United States
(12) Patent Application Publication
(10) Pub. No.: US 2006/0184316 A1
(43) Pub. Date: Aug. 17, 2006

(54) SYSTEM AND METHOD OF USING MAP DATA

(75) Inventors: Maguns HULTIN, Onsala (SE); Anders PIHL, Torslanda (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/308,304

(22) Filed: Mar. 15, 2006

Related U.S. Application Data
(63) Continuation-in-part of application No. PCT/SE03/01533, filed on Oct. 2, 2003.

(51) Int. Cl. G01C 21/32

(52) U.S. Cl. 701/208; 701/211; 340/995.1

(57) ABSTRACT

Method and arrangement for enabling vehicles of varying form and weight to use mass-produced planning map databases in a planning system. According to the invention, road elements are extracted from a route and it is determined if these road elements, either on their own or in combination with other road elements of the route or in direct connection with the route, could restrict the vehicle of varying form and weight of traveling along the route. If any of the road elements, alone or in combination, could cause a traveling restriction, the driver is alerted of this to allow him or her to take appropriate action.

### CROSS-REFERENCE TO RELATED APPLICATIONS

The present application is a continuation patent application of International Application No. PCT/SE2003/001533 filed 2 Oct. 2003 which was published in English pursuant to Article 21(2) of the Patent Cooperation Treaty. Said applications is expressly incorporated herein by reference in its entirety.

### TECHNICAL FIELD

This invention relates to a system and a method of using a map database of a route planning system, especially using a map database, which is incomplete for vehicles, which differ regarding one or more attributes in relation to vehicles for which the map database was developed. The method and the system are particularly appropriate for use with route planning of heavy vehicles when the underlying map database is developed for cars.

### BACKGROUND OF INVENTION

Route planning systems have become increasingly popular with land-based vehicles and are now becoming almost a standard accessory in the high-end segments of medium and large sized cars. This has generated an increased interest in developing and improving the map databases used by the route planning systems. The mass market for these map databases are thus users of cars, which cars are assumed to be constrained within certain physical limits regarding height, width, length, weight, turning capability and the like. This will result in users of vehicles with physical limits, attributes, which differ from, i.e. usually are greater than those assumed, cannot rely on the routes produced by means of map databases developed for the mass market of cars.

A solution would be to develop specific map databases for the vehicles that the system would be used with. An advantage of this is that the same, or basically the same, route planning system as those used in cars could be used, together with the specific map database. Unfortunately the development and the maintenance of map databases are extremely expensive, which would require very high end-user prices, or a mass market. It is probably difficult to achieve a mass market with a map database developed for a specific vehicle, and the price per unit sold would probably be so high that other methods of route planning would appear very cheap in comparison. Another, more probable, solution would be to modify an existing map database to suit a desired specific vehicle. As the previous solution, existing route planning systems could then be used, but unfortunately this would probably be very expensive as well. Additionally any modification done to a map database would have to be redone every time the source map database was updated.

There seems to be a need to, in a cost efficient manner, provide a route planning system to vehicles that comprise attributes that diverge from assumed attributes of cars.

### SUMMARY OF INVENTION

A purpose of the invention is to provide a method and a system, which enables land vehicles with divergent attributes in comparison to private/passenger cars, to be provided with a route planning system suitable for the land vehicles in a cost efficient manner.

A further purpose of the invention is to provide a method and a system which uses a map database developed and maintained for private/passenger cars, in a route planning system of a vehicle with one or more attributes that differ from the assumed attributes of private/passenger cars.

These purposes are attained according to the invention by enabling vehicles of varying form/geometry, characteristics and weight to use mass-produced map databases in a route planning system. According to the invention, road elements are extracted from a route and it is determined if these road elements, either on their own or in combination with other road elements of the route or other road elements in direct connection with the route, could restrict the vehicle of varying form, characteristics and weight, of traveling along the route. If any of the road elements, alone or in combination, could cause a traveling restriction, the driver is alerted of this to allow him or her to take appropriate action. The driver can be alerted in different manners and at different times and distances from the possibly troublesome road element or road elements.

These purposes are also attained according to the invention by a method of extending the use of a map database to a vehicle with one or more distinctive features. The distinctive features are of such a nature that they can influence a feasibility of the vehicle's continued travel on routes produced by means of the map database in comparison with vehicles for which the map database is primarily intended. If the map database is produced for use in cars such as private/passenger cars, then, for example, there is probably an assumption that they are of limited size and weight, and with certain characteristics, such as turning capability. According to the invention the method comprises a plurality of steps. In a first step a route is produced/created by means of the map database. In a second step the route is checked to determine if there are one or more road elements which are unspecified and which could be a possible interference to the vehicle's continued travel due to the one or more distinctive features of the vehicle. And finally in a third step, if there is a case of determined possible interference, the possible interference is indicated. The indication can be made when the route is created, and/or when the vehicle is coming closer to the possible interference.

These purposes are further attained according to the invention by a method of extending the use of a map database to a vehicle with one or more distinctive features. The distinctive features are such that they can influence a feasibility of the vehicle's continued travel on routes produced by means of the map database. According to the invention the method comprises a plurality of steps. In a first step a route is produced/created by means of the map database. In a second step it is determined if there is a presence of one or more potential restrictions along the produced route. The potential restrictions are of a nature so that they could interfere with the vehicle's continued travel due to the one or more distinctive features. In a third step it is indicated that there are one or more potential restrictions if it is determined that there is a presence of one or more potential restrictions.

In some version, it is suitable that the second step, the step of determining a presence, comprises a sub-step. The sub-step determines that there is a presence of one or more potential restrictions along the produced route if a road element of the route or a combination of road elements of the route is determined to be a potential restriction, or if one or more road elements of the route in combination with one or more road elements in connection with the route is determined to be a potential restriction, or if one or more road elements in connection with the route is determined to be a potential restriction. Advantageously the step of determining a presence comprises a further sub-step. The further sub-step can determine a road element as a potential restriction if the road element is unspecified. Or the further sub-step can determine a road element as a potential restriction only if the road element is unspecified with regard to one or more features, which are potentially restrictive for the type of road element the road element, belongs to. Or the further sub step can determine a road element as a potential restriction only if the road element is unspecified with regard to one or more features which are potentially restrictive for the type of road element the road element belongs to, and only if at least one of the one or more unspecified features is a feature which the vehicle has as a distinctive feature. Suitably a road element can for example be of a road element type of either one of a classified road, an unclassified road, a road within city limits, a road outside city limits, a road within an urban district, a road with a single lane, a one way road, a bridge, a tunnel, a single level crossing, a grade separated intersection, an intersection, a railway crossing, a dead-end street, or a roundabout.

Suitably a distinctive feature is one or more of a vehicle's length, height, width, total weight, axle pressure, load pressure, trail car, trail car weight, trail car axel pressure, trail car load pressure, trail car length, trail car width, trail car height, maximum speed, turning radius, or environmental classification.

Advantageously the method further comprises a step, which senses by means of sensors one or more of the distinctive features of the vehicle. The method can also further comprise a step of extracting from a supplied vehicle type one or more of the distinctive features of the vehicle. In some versions the method further comprises the step of pre-storing one or more of the distinctive features of the vehicle in the vehicle. Preferably the method further comprises the step of allowing/enabling manual input of one or more of the distinctive features of the vehicle.

Suitably the third step, the step of indicating, comprises indicating visually and/or orally.

The above-described method steps according to the invention can be combined in any desired manner, as long as there are no conflicts between the included method steps.

These purposes are also attained according to the invention by a route planning system adapted to use a map database together with a vehicle that comprises one or more distinctive features. The distinctive features are such that they can influence a feasibility of the vehicle's continued travel on routes produced by means of the map database in comparison with vehicles for which the map database is primarily intended. According to the invention the system is arranged to produce a route by means of the map database, and the system comprises route-checking means. The route checking means is arranged to determine if there are one or more road elements which are unspecified and which could be a possible interference to the vehicle's continued travel due to the one or more distinctive features. The system further comprises indicating means arranged to indicate the possible interference if the checking means has determined that there is a possible interference.

These purposes are also attained according to the invention by a route planning system adapted to use a map database in a vehicle with one or more distinctive features. The distinctive features being such that they can influence a feasibility of the vehicle's continued travel on routes produced by means of the map database. According to the invention the system is arranged to produce a route by means of the map database, and the system comprises determining means arranged to determine if there is a presence of one or more potential restrictions along the produced route. The potential restrictions are of a nature such that they could interfere with the vehicle's continued travel due to the one or more distinctive features. Further the system comprises indicating means arranged to indicate that there are one or more potential restrictions if it is determined that there is a presence of one or more potential restrictions along the produced route.

Suitably the determining means is arranged to determine that there is a presence of one or more restrictions along the produced route if a road element of the route or a combination of road elements of the route is determined to be a potential restriction, or if one or more road elements of the route in combination with one or more road elements in connection with the route is determined to be a potential restriction, or if one or more road elements in connection with the route is determined to be a potential restriction.

The determining means can in some embodiments be further arranged to determine that a road element is a potential restriction if the road element is unspecified. In other embodiments the determining means can be further arranged to determine a road element as a potential restriction only if the road element is unspecified with regard to one or more features, which are potentially restrictive for the type of road element the road element, belongs to. In still other embodiments the determining means can be further arranged to determine a road element as a potential restriction only if the road element is unspecified with regard to one or more features which are potentially restrictive for the type of road element the road element belongs to, and only if at least one of the one or more unspecified features is a feature which the vehicle has as a distinctive feature.

Suitably a road element can for example be of a road element type of either one of a classified road, an unclassified road, a road within city limits, a road outside city limits, a road within an urban district, a road with a single lane, a one way road, a bridge, a tunnel, a single level crossing, a grade separated intersection, an intersection, a railway crossing, a dead-end street, or a roundabout. Preferably a distinctive feature can be a vehicle's length, height, width, total weight, axle pressure, load pressure, trail car, trail car weight, trail car axel pressure, trail car load pressure, trail car length, trail car width, trail car height, maximum speed, turning radius, or environmental classification.

In some embodiments the system can suitably further comprise one or more sensors arranged to sense one or more of the distinctive features of the vehicle. The system can also further comprise extracting means arranged to extract from a supplied vehicle type one or more of the distinctive features of the vehicle. The system can still further also comprise memory means arranged to store one or more of the distinctive features of the vehicle in the vehicle. Some embodiments of the system can also further comprise input means arranged to accept manual input of one or more of the distinctive features of the vehicle.

Suitably the indicating means is arranged to indicate visually, and/or orally.

The features of the above-described different embodiment of a route planning system according to the invention can be combined in any desired manner, as long as no conflict occurs.

According to the invention, by providing a method that enables a vehicle to use a map database with insufficient data in relation to the vehicle, and by providing a route planning system that enables the use of the map database with insufficient data, a plurality of advantages over prior art methods and systems are obtained. Prior art route planning systems need a map database that is complete with regard to the vehicle that is using the system to thereby be able to provide accurate and reliable routes. A map database is considered complete for a vehicle if the database comprises sufficient information/data on all road elements that could possibly place a limitation on the vehicle's ability of travel on them. For example, a map database that is complete for use with a vehicle that is three meters high, would, for example, provide/comprise data, maximum passable height data or minimum internal height data, for at least tunnels that have an internal height of three and a half meters or less. Such a map database for a three meter high vehicle would not have to comprise data on for example tunnels that have an internal height of four meters, since they are assumed to be at least high enough for the vehicle in question. However, such a map database would not be able to provide accurate and safe routes for vehicles that are four meters high, i.e. the map database that is complete for a three meter high vehicle is not necessarily complete for a four meter high vehicle. It all depends on what assumptions are made during the data collection for a map database, i.e. for what type of vehicle is the map database intended.

The present invention will enable a user of a vehicle for which a map database could be incomplete, to use the map database with a much higher degree of confidence. The method/system according to the invention will extract road elements with unspecified features and determine if they possibly could be a limitation to a vehicle in question. The presence of road elements that there is an uncertainty about, will be alerted to the driver, so that the driver can take appropriate action. Appropriate action will depend on the specific situation and road element, but could involve just optically keeping a lookout for road signs to clarify the situation, to choosing a different route. Road elements with specified features that pose a restriction to the vehicle in question will be handled as well. By implementing the invention users of vehicles with diverging feature (s) can use a map database which is incomplete for the vehicle with the diverging feature (s), and travel on routes with confidence in that any potential problem will be alerted well in advance.

Other features and advantages of this invention will become apparent from the following description.

### BRIEF DESCRIPTION OF THE DRAWINGS

The invention will now be described in more detail for explanatory, and in no sense limiting, purposes, with reference to following figures in which:

FIG. 1 illustrates a basic route planning system comprising an implementation of the invention;

FIG. 2 illustrates a flow diagram of a basic method according to the invention; and

FIG. 3 illustrates a flow diagram of an extend method according to the invention.

### DETAILED DESCRIPTION

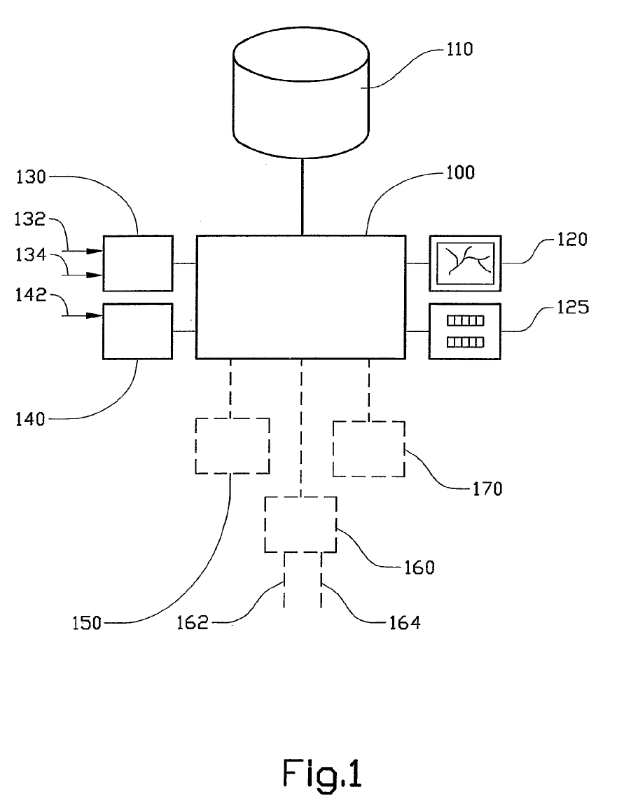

In order to clarify the method and the system according to the invention, some examples of its function and use will now be described in connection with FIGS. 1 to 3.

FIG. 1 illustrates an example of a basic route planning system comprising a central unit 100 interconnected with a map database 110, one or more output devices 120 such as visual displays/screens and speakers, a user input interface 125 such as a key set or voice recognition, an input interface 130 for vehicle sensors such as a vehicle speed sensor 132 and a steering angle sensor 134, an input interface 140 for location determination being connected to or comprising a location determination sensor 142, e.g. GPS.

To use a route planning system, a user/driver will typically first enter a present location, if this is not already available in/to the system, and then enter a desired destination by means of the user input interface 125, usually in combination with a visual display 120. There could be a possibility that the user is able to enter a preference of either a short travel time or a short travel distance. Some advanced system will even allow a user to remove certain types of road elements, such as ferries, from a calculated route. The route planning system 100 will then calculate one or more routes according to the given criteria by means of the map database 110. The user in his or her vehicle will then be guided along the calculated route visually and/or orally. The route planning system will keep track of the location of the vehicle along the route by means of vehicle sensors 132,134 through an input interface 130, and/or by means of a location determination sensor 142, such as a GPS (Global Positioning System), through an appropriate input interface 140. As the vehicle's location changes, the route planning system will guide the user/vehicle along the route.

Problems will arise if the route planning system guides the user/vehicle along road elements that the vehicle cannot, or has difficulties to, travel along. There can be a very unpleasant surprise for the driver of the vehicle if the route planning system, for example, directs the vehicle through a tunnel with an opening that is lower than the maximum height of the vehicle, assuming that the driver follows the directions without any further thought. This situation will normally not occur for a personal/private car without anything on the roof, since the route planning system in conjunction with a mass produced map database for cars will only select road elements for a route that are travelable by normal sized cars. However, if the system is used in a vehicle with features that deviate from what the route planning system and the map database considers normal, then serious accidents could happen if the route planning system is relied upon to provide safe and travelable roads. As mentioned above, custom-made route planning systems and custom made map databases could be used. However, this is normally not economically feasible.

According to the invention, a lightly modified route planning system, as the one described above, together with a standard map database can be used to provide routes for vehicles with deviating features, such as longer, higher, wider, and/or heavier vehicles. The route planning system will in most embodiments need to know at least the deviating features, either directly or indirectly. These features are stored in a vehicle data memory 150, which will provide the route planning system with information on how to handle road elements of a route. These features, or for example a type/make of the vehicle, can be pre-stored, manually inputted by means of an input interface 170, which can be the same as that for ordinary manual input 125 to the route planning system, and/or automatically and/or semi-automatically sensed by sensors such as an axel load sensor 162 and/or a trailer sensor 164 via a sensor input interface 160.

According to the invention, road elements of a route are checked as to whether they are unspecified regarding one or more features that are of significance to a road element in question. Important/significant features of, for example a tunnel, are its minimum internal height and possibly its width. A tunnel road element is thus considered to be unspecified if it does not contain any information/data about its minimum internal height. In a most basic embodiment of the invention, all unspecified road elements are considered a potential obstacle to the vehicle. According to the invention, the route planning system can, when there is a potential obstacle, either reroute, if, for example, it is a route that is routed by the route planning system, or provide one or more warnings to the driver that there might be problems ahead. If all unspecified road elements are considered as potential obstacles, then there might be unnecessary rerouting performed, and/or unnecessary warnings given. To remedy this, in a preferred embodiment of the invention, only unspecified road elements comprising an unspecified feature that a vehicle in question has as a deviating feature, are considered as potential obstacles.

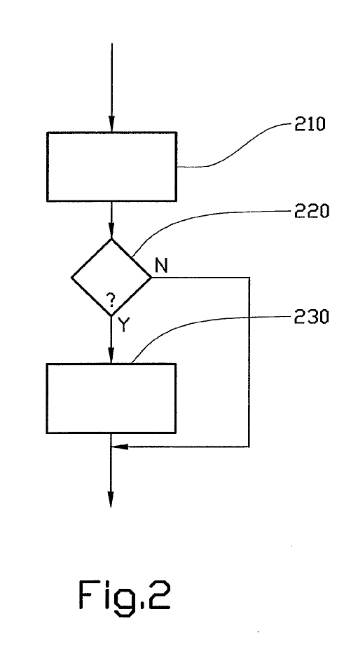

FIG. 2 shows a basic method according to the invention that could be applied to a route planning system according to FIG. 1. In a first step 210 a route is created by means of a map database. The route can be manually entered, or automatically generated. From the first step 210, in a second step 220 it is determined if there are any possible restrictions, potential obstacles, in the retrieved route from the map database. The procedure will continue with a third step 230 if there are possible/potential restrictions, potential obstacles, along the route, otherwise the third step 230 is canceled. In the third step 230 it is indicated that there are possible/potential obstacles/restrictions along the route, suitably the driver is recommended to keep a lookout for road conditions and road signs. Alternatively an alternate route is calculated.

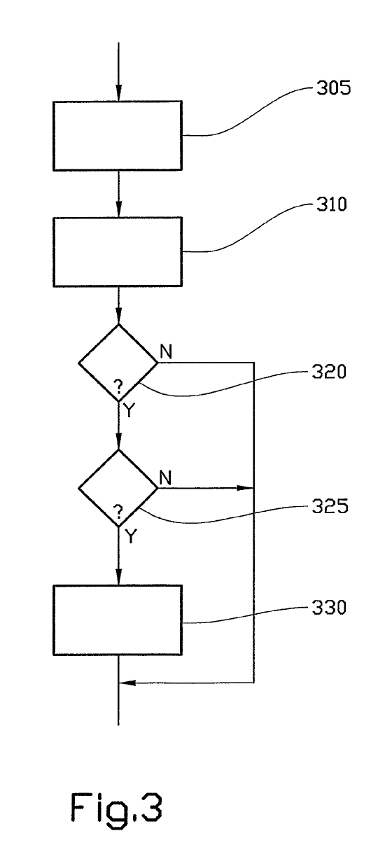

FIG. 3 illustrates an extend method according to the invention. First of all in a first step 305 one or more attributes, deviating features, of the vehicle are stored/inputted, by selecting a type of vehicle, preprogrammed, manually and/or automatically. In a second step a route is produced by means of information retrieved from a map database. From the second step 310, in a third step 320 it is determined if there are any possible/potential restrictions/obstacles in the route from the map database. The procedure continues with a fourth step 325 in case there are possible/potential restrictions on the route, otherwise the procedure is terminated. In the fourth step 325 it is determined if the possible restrictions along the route can have any relevancy in relation to the vehicle's stored attribute or attributes. The procedure will continue with a fifth step 330 in case the possible/potential restrictions could have relevance, otherwise the procedure terminates. In the fifth step 330, there is an indication that there are possible/potential restrictions along the route, suitably the driver is recommended to keep a lookout for road conditions and road signs.

The above-described method steps do not have to be performed in the order according to the described examples. The only restriction to the order in which the method steps are performed is that a step that requires results of other steps is performed after these other steps have been performed and delivered their results. The steps can generally be performed in any desired order and/or in parallel to a desired extent.

There are many different types of route planning systems and these may deviate from our examples. For example, some, as illustrated, comprise a GPS, and some comprise other location determination means. The illustrated basic route planning system is just an example to illustrate the invention and should not be seen as a restriction. The invention is not restricted to be implemented onto a specific type of route planning system. The only prerequisite is that a route planning system that the invention is to be implemented with, comprises a map database from which the route planning system can create a route comprising road elements. This will cover most, if not all, conventional route planning systems. The created route can either be calculated from a given start, possibly a current position, to a given destination position, be from a route which is manually inputted or for example pre-stored in the range of from a smaller extent through to a completely given route, or be from an automatic look-ahead function.

Most route planning systems will accept a start location and a destination location and calculate a route between these two locations. Certain systems will accept manual modifications to a calculated route, making the created route given to some extent. A route can be predetermined, making a complete route given or a part of a calculated route given. An advanced feature of the invention, to enable full use of a route planning system in vehicles of varying form and weight, is to create a route from a look-ahead/predictive function. A predictive function according to the invention makes an assumption of where the vehicle will travel, based, for example, on a present location, speed, and direction as well as on a previous location, speed and direction. For example, if a vehicle travels along a road at a constant, or near constant, speed, the system could then assume that the vehicle will continue to travel along the same road, then a route along the road could be created. This will allow a system according to the invention to be able to warn for possible problems ahead, even though a destination is not programmed into the system.

The description has described how vehicles, such as trucks, can use a route planning system with a map database that is developed for a passenger car mass market, and be warned about potential difficulties.

As a summary, the invention can basically be described as a method and system, which provides route planning system capabilities to trucks and other large vehicles. This is accomplished by analyzing road elements of a route, which is composed of information from a map database, and warn for potentially dangerous/restrictive road elements, i.e. road elements where the information about the road element(s) is insufficient to conclude that there are no restrictions/dangers.

The invention is not limited to the embodiments described above but may be varied within the scope of the appended patent claims.

FIG. 1 shows a basic route planning system to which the invention can suitably be implemented:
100 The central unit of the route planning system;
110 Map database;
120 Screen;
125 Input interface, e.g. a key set or voice recognition;
130 Input interface for vehicle sensors;
132 Vehicle speed sensor;
134 Steering angle sensor;
140 Input interface for location determination;
142 Location determination sensor, e.g. GPS;
150 Vehicle data memory, possibly pre-stored, manually inputted, automatically and/or semi-automatically sensed;
160 Input interface for vehicle data, e.g. dynamic vehicle data such as axle load and trailer;
162 Axel load sensor;
164 Trailer sensor;
170 Input interface for manually inputted vehicle data.

FIG. 2 shows a basic method according to the invention that could be applied to a route planning system according to FIG. 1:
210 Begin procedure: A first step retrieves a route by means of a map database;
220 From the first step: A second step where it is determined if there are any possible restrictions in the retrieved route from the map database, the procedure continues with a third step if there are possible restrictions along the route, otherwise the third step is canceled;
230 From the second step if there are possible restrictions along the route: The third step where it is indicated that there are possible restrictions along the route, suitably the driver is recommended to keep a look-out for road conditions and road signs.

FIG. 3 shows an extend method according to the invention:
305 Begin procedure: One or more attributes of the vehicle are stored/inputted, by choice of vehicle, preprogrammed, manually and/or automatically;
310 From step 305: A route is produced by means of a map database;
320 From step 310: It is determined if there are any possible restrictions in the route from the map database, the procedure continues with step 325 in case there are possible restrictions on the route, otherwise the procedure is terminated;
325 From step 320 in case there are possible restrictions along the route: It is determined if the possible restrictions along the route can have any relevancy in relation to the vehicle's stored attribute or attributes, the procedure continues with step 330 in case the possible restrictions can have a relevance, otherwise the procedure terminates;
330 From step 325 in case the possible restrictions can have a relevance: There is an indication that there are possible restrictions along the route, suitably the driver is recommended to keep a look-out for road conditions and road signs.

What is claimed is:

1. A method of extending the use of a map database to a vehicle with one or more distinctive features, which distinctive features can influence a feasibility of the vehicle's continued travel on routes produced by means of the map database in comparison with vehicles for which the map database is primarily intended, the method comprising:
producing a route by means of the map database;
checking the route to determine if there are one or more road elements which are unspecified and which could be a possible interference to the vehicle's continued travel due to the one or more distinctive features of the vehicle; and
indicating the possible interference if this is the case.

2. A method of extending the use of a map database to a vehicle with one or more distinctive features, which distinctive features can influence a feasibility of the vehicle's continued travel on routes produced by means of the map database, the method comprising:
producing a route by means of the map database;
determining if there is a presence of one or more potential restrictions along the produced route, which potential restrictions could interfere with the vehicle's continued travel due to the one or more distinctive features; and
indicating that there is one or more potential restrictions if it is determined that there is a presence of one or more potential restrictions.

3. The method as recited in claim 2, wherein the step of determining a presence comprises determining that there is a presence of one or more potential restrictions along the produced route if a road element of the route or a combination of road elements of the route is determined to be a potential restriction, or if one or more road elements of the route in combination with one or more road elements in connection with the route is determined to be a potential restriction, or if one or more road elements in connection with the route is determined to be a potential restriction.

4. The method as recited in claim 3, wherein the step of determining a presence further comprises determining a road element as a potential restriction if the road element is unspecified.

5. The method as recited in claim 3, wherein the step of determining a presence further comprises determining a road element as a potential restriction only if the road element is unspecified with regard to one or more features, which are potentially restrictive for the type of road element the road element, belongs to.

6. The method as recited in claim 3, wherein the step of determining a presence further comprises determining a road element as a potential restriction only if the road element is unspecified with regard to one or more features which are potentially restrictive for the type of road element the road element belongs to, and only if at least one of the one or more unspecified features is a feature which the vehicle has as a distinctive feature.

7. The method as recited in claim 3, wherein the road element is of a road element type of either one of a classified road, an unclassified road, a road within city limits, a road outside city limits, a road within an urban district, a road with a single lane, a one way road, a bridge, a tunnel, a single level crossing, a grade separated intersection, an intersection, a railway crossing, a dead-end street, or a roundabout

8. The method as recited in claim 2, wherein a distinctive feature is a vehicle's length, height, width, total weight, axle pressure, load pressure, trail car, trail car weight, trail car axel pressure, trail car load pressure, trail car length, trail car width, trail car height, maximum speed, turning radius, or environmental classification.

9. The method as recited in claim 2, further comprising sensing by means of sensors one or more of the distinctive features of the vehicle.

10. The method as recited in claim 2, further comprising extracting from a supplied vehicle type one or more of the distinctive features of the vehicle.

11. The method as recited in claim 2, further comprising pre-storing one or more of the distinctive features of the vehicle in the vehicle.

12. The method as recited in claim 2, further comprising manually inputting one or more of the distinctive features of the vehicle.

13. The method as recited in claim 2, wherein the step of indicating comprises indicating visually.

14. The method as recited in claim 2, wherein the step of indicating comprises indicating orally.

15. A planning system adapted to use a map database together with a vehicle that comprises one or more distinctive features, which distinctive features can influence a feasibility of the vehicle's continued travel on routes produced by means of the map database in comparison with vehicles for which the map database is primarily intended, wherein the system is arranged to produce a route by means of the map database, and in that the system comprises route checking means, which checking means is arranged to determine if there are one or more road elements which are unspecified and which could be a possible interference to the vehicle's continued travel due to the one or more distinctive features, and in that the system comprises indicating means arranged to indicate the possible interference if the checking means has determined that there is a possible interference.

16. A planning system adapted to use a map database in a vehicle with one or more distinctive features, which distinctive features can influence a feasibility of the vehicle's continued travel on routes produced by means of the map database, wherein the system is arranged to produce a route by means of the map database, and in that the system comprises determining means arranged to determine if there is a presence of one or more potential restrictions along the produced route, which potential restrictions could interfere with the vehicle's continued travel due to the one or more distinctive features, and in that the system further comprises indicating means arranged to indicated that there are one or more potential restrictions if it is determined that there is a presence of one or more potential restrictions along the produced route.

17. The planning system as recited in claim 16, wherein the determining means is arranged to determine that there is a presence of one or more restrictions along the produced route if a road element of the route or a combination of road elements of the route is determined to be a potential restriction, or if one or more road elements of the route in combination with one or more road elements in connection with the route is determined to be a potential restriction, or if one or more road elements in connection with the route is determined to be a potential restriction.

18. The planning system as recited in claim 17, wherein the determining means is further arranged to determine that a road element is a potential restriction if the road element is unspecified.

19. The planning system as recited in claim 17, wherein the determining means is further arranged to determine a road element as a potential restriction only if the road element is unspecified with regard to one or more features which are potentially restrictive for the type of road element the road element belongs to.

20. The planning system as recited in claim 17, wherein the determining means is further arranged to determine a road element as a potential restriction only if the road element is unspecified with regard to one or more features which are potentially restrictive for the type of road element the road element belongs to, and only if at least one of the one or more unspecified features is a feature which the vehicle has as a distinctive feature.

21. The planning system as recited in claim 17, further comprising a road element of a type of either one of a classified road, an unclassified road, a road within city limits, a road outside city limits, a road within an urban district, a road with a single lane, a one way road, a bridge, a tunnel, a single level crossing, a grade separated intersection, an intersection, a railway crossing, a dead-end street, or a roundabout.

22. The planning system as recited in claim 16, wherein a distinctive feature is a vehicle's length, height, width, total weight, axle pressure, load pressure, trail car, trail car weight, trail car axel pressure, trail car load pressure, trail car length, trail car width, trail car height, maximum speed, turning radius, or environmental classification.

23. The planning system as recited in claim 16, further comprising one or more sensors arranged to sense one or more of the distinctive features of the vehicle.

24. The planning system as recited in claim 16, further comprising extracting means arranged to extract from a supplied vehicle type one or more of the distinctive features of the vehicle.

25. The planning system as recited in claim 16, further comprising memory means arranged to store one or more of the distinctive features of the vehicle in the vehicle.

26. The planning system as recited in claim 16, further comprising input means arranged to accept manual input of one or more of the distinctive features of the vehicle.

27. The planning system as recited in claim 16, wherein the indicating means is arranged to indicate visually.

28. The planning system as recited in claim 16, wherein the indicating means is arranged to indicate orally.

29. The method as recited in claim 1, wherein said method is executed by a computer running a computer program including program code.

30. The method as recited in claim 2, wherein said method is executed by a computer running a computer program including program code.

31. The method as recited in claim 1, wherein said method is embodied in a computer program product comprising program code stored on a medium that can be read by computer for carrying out the method when the said program is executed by a computer.

32. The method as recited in claim 2, wherein said method is embodied in a computer program product comprising program code stored on a medium that can be read by computer for carrying out the method when the said program is executed by a computer.
